(19) United States
(12) Patent Application Publication
(10) Pub. No.: US 2014/0096921 A1
(43) Pub. Date: Apr. 10, 2014

(54) OPERATING DEVICE FOR SOLAR RADIATION SHIELDING DEVICE AND CORD SUPPORTING PART FOR SOLAR RADIATION SHIELDING DEVICE

(71) Applicant: TACHIKAWA CORPORATION, Tokyo (JP)

(72) Inventor: Eiji Kawai, Tokyo (JP)

(73) Assignee: TACHIKAWA CORPORATION, Tokyo (JP)

(21) Appl. No.: 14/119,795

(22) PCT Filed: May 23, 2012
(86) PCT No.: PCT/JP2012/063190

§ 371 Date: Nov. 22, 2013

(30) Foreign Application Priority Data
May 26, 2011 (JP) 2011-118530

(51) Int. Cl. E06B 9/36; A47H 5/032

(52) U.S. Cl. CPC E06B 9/36; A47H 5/032
USPC 160/370

(57) ABSTRACT

By operating an endless operation cord so that the operation cord moves around in a rail, a sunlight shielding material is transferred along the rail. The operation cord includes a pair of cord portions extending in parallel with each other along the rail, a first endless edge hanging from one end of the rail, and a second endless edge supported in the rail through a cord support unit. A cord support unit includes positioning release means configured to, when a tensile force is applied to both the cord portions at the second endless edge, release positioning of the second endless edge with respect to the rail and a guide member configured to, when the positioning of the second endless edge is released, allow the second endless edge to move at least until the first endless edge reaches the floor.

### TECHNICAL FIELD

The present invention relates to an operation apparatus for sunlight shielding apparatuses, including vertical blinds and curtains.

### BACKGROUND ART

In a vertical blind, slats are rotatably suspended from and supported by many runners which are supported in such a manner to be movable in the hanger rail. By operating an operation apparatus, the runners are moved along the hanger rail and thus the slats are drawn out or folded up. Alternatively, by operating the operation apparatus, the slats are rotated.

In one type of operation apparatus, slats are transferred using an operation cord hanging from one end of a hanger rail; the slat angle is adjusted using an operation baton hanging from the same end of the hanger rail.

The operation cord has an endless shape and is movably routed over the entire length of the hanger rail. The operation cord is connected only to the leading runner of the many runners. By operating the operation cord, the leading runner moves and thus the following runners follow suit, so that the slats are drawn out. Alternatively, by operating the operation cord, the leading runner pushes back the following runners and thus the slats are folded up at one end of the hanger rail.

Patent Document 1 discloses a vertical blind where an operation cord routed in a hanger rail is connected to a leading runner and where by operating the operation cord, slats can be drawn out or folded up.

Patent Document 2 discloses a double-sided vertical blind where two operation cords are routed through a hanger rail and where by operating the operation cords, slats are drawn out from both ends of the hanger rail toward the center thereof or folded up at both ends thereof.

### PRIOR ART DOCUMENTS

### Patent Documents

Patent Document 1: Japanese Unexamined Patent Application Publication No. 2006-183275
Patent Document 2: Japanese Patent No. 3905864
Patent Document 3: Japanese Examined Utility Model Registration Application Publication No. 3-17740
Patent Document 4: Japanese Patent No. 3545649

### SUMMARY OF THE INVENTION

### Problems to be Solved by the Invention

In the above vertical blinds, the endless operation cord hangs from one end of the hanger rail. For this reason, a dweller or the like who moves in the room may be caught on the operation cord and thus hindered from moving, or a mobile object caught on the operation cord or the operation cord may be broken.

Patent Document 3 discloses a pulley case including a pulley with which a string routed through a curtain rail is engaged and an adjustment apparatus for adjusting the tension of the string. For a curtain including such a pulley case, when a dweller or the like is caught on the string hanging from a curtain rail, the dweller or the like is allowed to move in the string tension adjustment range.

However, there is a limit to the string tension adjustment range. For this reason, it is not possible to reliably prevent such as hindrance to the movement of the dweller.

Patent Document 4 discloses a vertical blind as a second embodiment. In this vertical blind, one end of an operation cord is engaged with a pulley which is positioned at an end of a hanger rail. For this reason, when a dweller or the like is caught on the operation cord hanging from the hanger rail, the dweller or the like is hindered from moving.

On the other hand, when a dweller or the like is caught on a pitch drive cord hanging from the hanger rail, a magnet-equipped leading runner is detached from a magnet receptor. Nevertheless, the operation cord moves around in the hanger rail along with the magnet-equipped leading runner and thus the pitch drive cord is hindered from moving. For this reason, it is not possible to reliably prevent such as hindrance to the movement of the dweller or the like.

An object of the present invention is to provide an operation apparatus which, in a sunlight shielding apparatus where a sunlight shielding material is transferred using an operation cord routed through a rail, prevents the operation cord from hindering movement of a dweller or the like.

### Means for Solving the Problems

The present invention provides an operation apparatus for a sunlight shielding apparatus. The sunlight shielding apparatus includes: a sunlight shielding material; a rail configured to support the sunlight shielding material in such a manner that the sunlight shielding material is movable; and an endless operation cord supported by the rail in such a manner that the operation cord can move around along the rail. The sunlight shielding material is transferred along the rail as the operation cord moves around in the rail. The operation cord includes: a pair of cord portions extending in parallel with each other along the rail; a first endless edge which is a junction of first ends of the cord portions; and a second endless edge which is a junction of second ends of the cord portions. The first endless edge hangs from one end of the rail, and the second endless edge is supported in the rail through the cord support unit. The cord support unit includes: positioning release means configured to, when a tensile force is applied to both the cord portions at the second endless edge, release positioning of the second endless edge with respect to the rail; and a guide member configured to, when the positioning of the second endless edge is released, allow the second endless edge to move at least until the first endless edge reaches a floor.

In one aspect of the present invention, the positioning release means preferably includes restoration means configured to elastically restore the positioning of the second endless edge with respect to the rail.

In one aspect of the present invention, the restoration means preferably includes an operation baton capable of transferring, to the positioning release means, an end case with which the operation cord is engaged.

In one aspect of the present invention, the positioning release means preferably includes locking means attached to the rail and configured to elastically hold an end case included in the cord support unit.

In one aspect of the present invention, the cord support unit preferably includes: a cap mounted on an end of the rail; and an end case with which the operation cord is engaged, the end case being movably supported by the rail, and the positioning release means preferably includes a locking piece disposed on the cap and configured to elastically hold the end case.

In one aspect of the present invention, the cap preferably includes a planar portion covering an end of the rail, and the locking piece preferably protrudes from the planar portion.

In one aspect of the present invention, the cap preferably includes a guide protrusion protruding from the planar portion, and the end case preferably has a guide hole into which the guide protrusion can be inserted.

In one aspect of the present invention, the cord support unit preferably includes: an operation unit mounted on an end of the rail; and an end case with which the operation cord is engaged, the end case being movably supported by the rail, and the positioning release means preferably includes a locking piece disposed on the operation unit and configured to elastically hold the end case.

In one aspect of the present invention, the operation unit preferably includes a guide roller configured to guide the operation cord from an end of the rail downward.

In one aspect of the present invention, the operation units are preferably mounted on both ends of the rail; the operation units preferably hold the end cases, respectively; the operation cord engaged with the end case located at a left end of the rail preferably hangs from a right end of the rail; and the operation cord engaged with the end case located at the right end of the rail preferably hangs from the left end of the rail.

In one aspect of the present invention, the cord support unit preferably includes: a separate stopper attached to a lengthwise middle portion of the rail; a first end case with which the operation cord hanging from a right end of the rail is engaged, the first end case being movably supported by the rail; and a second end case with which the operation cord hanging from a left end of the rail is engaged, the second end case being movably supported by the rail, and the positioning release means preferably includes a locking piece disposed on the separate stopper and configured to elastically hold the first and second end cases.

In one aspect of the present invention, the locking piece preferably includes a locking protrusion, and the end case preferably has a holding surface capable of being engaged with the locking protrusion.

In one aspect of the present invention, the end case disengaged from the locking piece is preferably movable along the rail with a height of the holding surface maintained at a height of the locking piece.

In one aspect of the present invention, the end case preferably includes a guide roller with which the operation cord is engaged.

In one aspect of the present invention, the end case is preferably movably supported in the rail.

In one aspect of the present invention, the end case preferably has a bearing hole into which an angle adjustment shaft configured to rotate the sunlight shielding material can be inserted.

In one aspect of the present invention, the positioning release means preferably includes locking means disposed on the end case with which the operation cord is engaged, the locking means being configured to elastically hold the end case on the rail.

In one aspect of the present invention, the locking means is preferably an elastic piece disposed on the end case, and the elastic piece is preferably configured to be engaged with an end of the rail or a locking hole formed in the rail.

In one aspect of the present invention, the positioning release means preferably elastically holds, on the rail, a guide portion with which the operation cord is engaged.

In one aspect of the present invention, the cord support unit is preferably movably fitted to the rail.

In one aspect of the present invention, the guide member preferably includes a suspension portion configured to suspend and support an end of the sunlight shielding material.

In one aspect of the present invention, the positioning release means is preferably configured to, when there is applied a tensile force exceeding a tensile force applied to the operation cord when transferring the sunlight shielding material, release the positioning of the second endless edge with respect to the rail.

The present invention also provides a cord support unit for a sunlight shielding apparatus. A sunlight shielding apparatus includes: a sunlight shielding material; a rail configured to support the sunlight shielding material in such a manner that the sunlight shielding material is movable; and an endless operation cord supported by the rail in such a manner that the operation cord can move around in the rail. The sunlight shielding material is transferred along the rail as the operation cord moves around in the rail. The operation cord includes: a pair of cord portions extending in parallel with each other along the rail; a first endless edge which is a junction of first ends of the cord portions; and a second endless edge which is a junction of second ends of the cord portions. The first endless edge hangs from one end of the rail, and the second endless edge is supported in the rail through the cord support unit. The cord support unit includes positioning release means configured to, when a tensile force is applied to both the cord portions at the second endless edge in the same direction, release positioning of the second endless edge with respect to the rail.

The present invention also provides a cord support unit attached to a lengthwise middle portion of a rail of a sunlight shielding apparatus. The cord support unit includes: a first end case with which an operation cord hanging from a right end of the rail is engaged, the first end case being movably supported by the rail; a second end case with which an operation cord hanging from a left end of the rail is engaged, the second end case being movably supported by the rail; and a locking piece disposed on the lengthwise middle portion of the rail and configured to elastically hold the first and second end cases.

### Effect of the Invention

According to the present invention, it is possible to, in a sunlight shielding apparatus where a sunlight shielding material is transferred using an operation cord routed through a rail, prevent the operation cord from hindering movement of a dweller or the like.

### BRIEF DESCRIPTION OF THE DRAWINGS

FIG. 1 is a front view showing a single-sided vertical blind.

FIG. 2 is a side view showing the single-sided vertical blind.

FIG. 3 is a front view showing an operation apparatus for the single-sided vertical blind.

FIG. 4 is a plan view showing the operation apparatus for the single-sided vertical blind.

FIG. 5 is a side view showing the operation apparatus for the single-sided vertical blind.

FIG. 6 is an exploded perspective view showing a cap and an end case.

FIG. 7 is a plan view showing an operation of the operation apparatus.

FIG. 8 is a front view showing a second embodiment.

FIG. 9 is a plan view showing the second embodiment.

FIG. 10 is a front view showing a third embodiment.

FIG. 11 is a plan view showing the third embodiment.

FIG. 12 is a schematic view showing an operation of a first embodiment.

FIG. 13 is a schematic view showing the operation of the first embodiment.

FIG. 14 is a schematic view showing an operation of a fourth embodiment.

FIG. 15 is a schematic view showing the operation of the fourth embodiment.

FIG. 16 is a sectional view showing a fifth embodiment.

FIG. 17 is a schematic view showing an operation of the fifth embodiment.

FIG. 18 is a schematic view showing the operation of the fifth embodiment.

FIG. 19 is a schematic view showing an operation of a sixth embodiment.

FIG. 20 is a schematic view showing the operation of the sixth embodiment.

FIG. 21 is a perspective view showing a seventh embodiment.

FIG. 22 is a sectional view showing the seventh embodiment.

FIG. 23 is a plan view showing the seventh embodiment.

FIG. 24 is a sectional view showing the seventh embodiment.

FIG. 25 is a sectional view showing an operation of the seventh embodiment.

FIG. 26 is a perspective view showing an outline of an eighth embodiment.

FIG. 27 is a sectional view showing the eighth embodiment.

FIG. 28 is a sectional view showing the eighth embodiment.

FIG. 29 is a bottom view showing the eighth embodiment.

FIG. 30 is a sectional view showing an operation of the eighth embodiment.

### EMBODIMENTS

### First Embodiment

Now, a first embodiment of the present invention will be described with reference to the drawings. In the present embodiment, there is shown a single-sided vertical blind, where slats are drawn out from one end of a hanger rail toward the other end or folded up from the other end toward the one end.

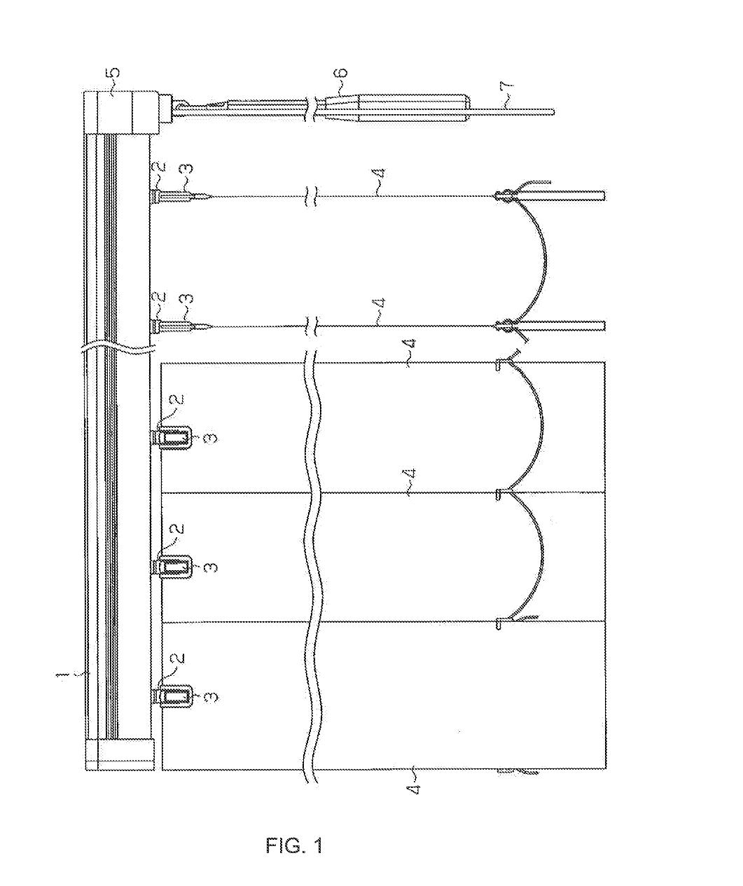

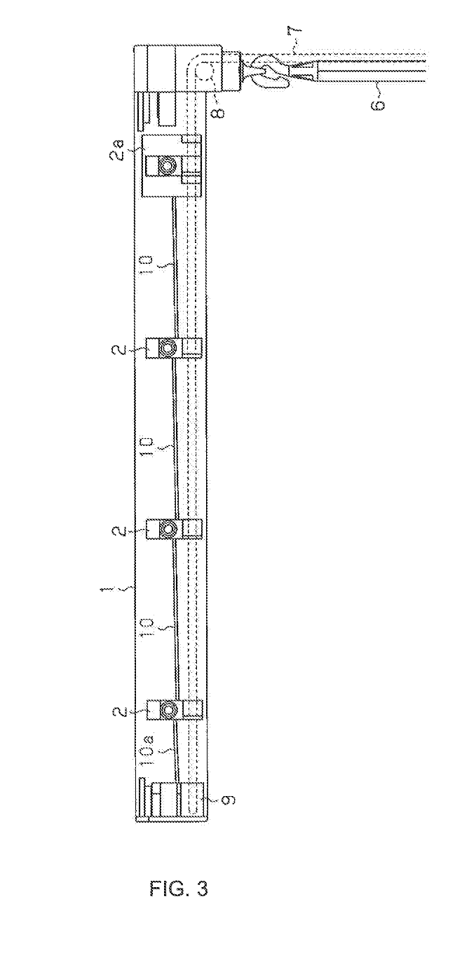

In a vertical blind shown in FIGS. 1 to 4, many runners 2 are supported by a hanger rail 1 in such a manner that the runners 2 can move along the hanger rail 1, and slats 4 are suspended from and supported by hooks 3 disposed on the runners 2.

An operation unit 5 is mounted on the right end of the hanger rail 1, and an operation baton 6 configured to adjust the angle of the slats 4 hangs from the operation unit 5. By rotating the operation baton 6, an angle adjustment shaft which is rotatably supported in the hanger rail 1 is rotated through a gear box in the operation unit 5. Thus, the hooks 3 are rotated through warm mechanisms in the runners 2. That is, by rotating the operation baton 6, the slats 4 are rotated in the same phase.

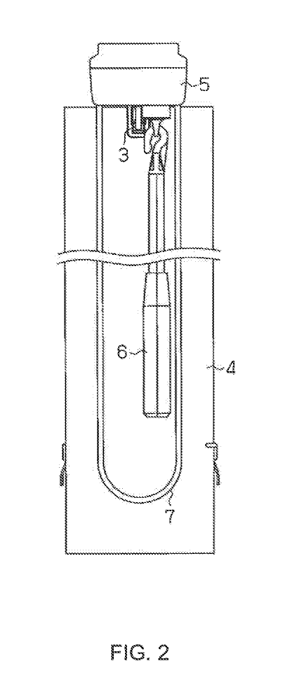

By operating an endless operation cord 7 hanging from the operation unit 5, the slats 4 can be drawn out or folded up along the hanger rail 1. The operation cord 7 includes a pair of cord portions extending in parallel with each other along the hanger rail 1, a first endless edge which is the junction of first ends of the cord portions, and a second endless edge which is the junction of second ends of the cord portions. As shown in FIGS. 2 to 4, with one endless edge (first endless edge) hanging from the operation unit, the cord portions are guided around a guide roller 8 supported by the operation unit 5 through front and rear areas in the hanger rail (the cord portions will be referred to as the front and rear cord portion, respectively). The other endless edge (second endless edge) is engaged with a cord support unit 9 mounted on the left end of the hanger rail 1.

By operating the operation cord 7 hanging from the operation unit 5, the front and rear cord portions of the operation cord 7 in the hanger rail 1 move in opposite directions.

Of the runners 2, a leading runner 2a is closest to the operation unit 5. The front cord portion of the cord portions of the operation cord 7 is connected to the leading runner 2a in the hanger rail 1.

Accordingly, when the front cord portion moves in the direction of arrow A shown in FIG. 4, the leading runner 2a moves in the direction of arrow A as well; when the front cord portion moves in the direction of arrow B, the leading runner 2a moves in the direction of arrow B as well.

The runners 2 and 2a are connected together through spacers 10. The maximum separation distances between the runners 2 and between the runner 2 and the runner 2a are equalized by the spacers 10. The maximum separation distance between the leftmost runner 2 in the hanger rail 1 and the cord support unit 9 is defined by an end spacer 10a. The maximum separation distance defined by the end spacer 10a is half that defined by the other spacers 10.

According to the above configuration, when the leading runner 2a moves in the direction of arrow A by operating the operation cord 7, the following runners 2 are sequentially drawn out in the same direction. Thus, the slats 4 are drawn out toward the right end of the hanger rail.

In contrast, when the leading runner 2a moves in the direction of arrow B, the following runners 2 are sequentially pushed back in the same direction by the leading runner 2a. Thus, the slats 4 are folded up toward the left end of the hanger rail.

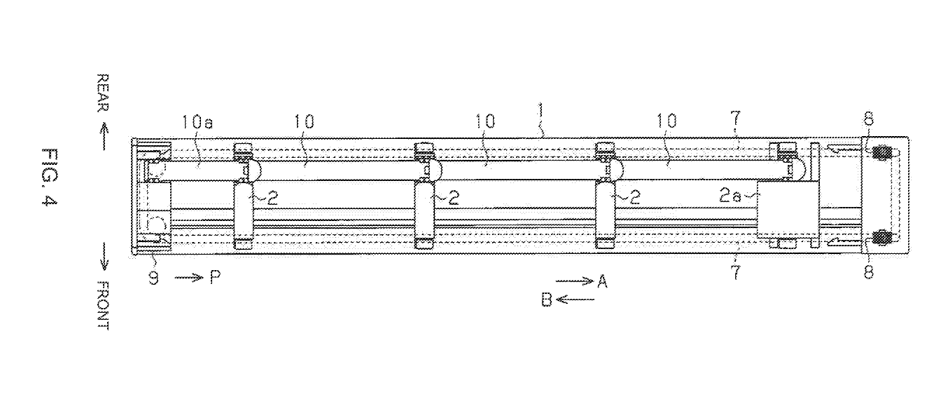

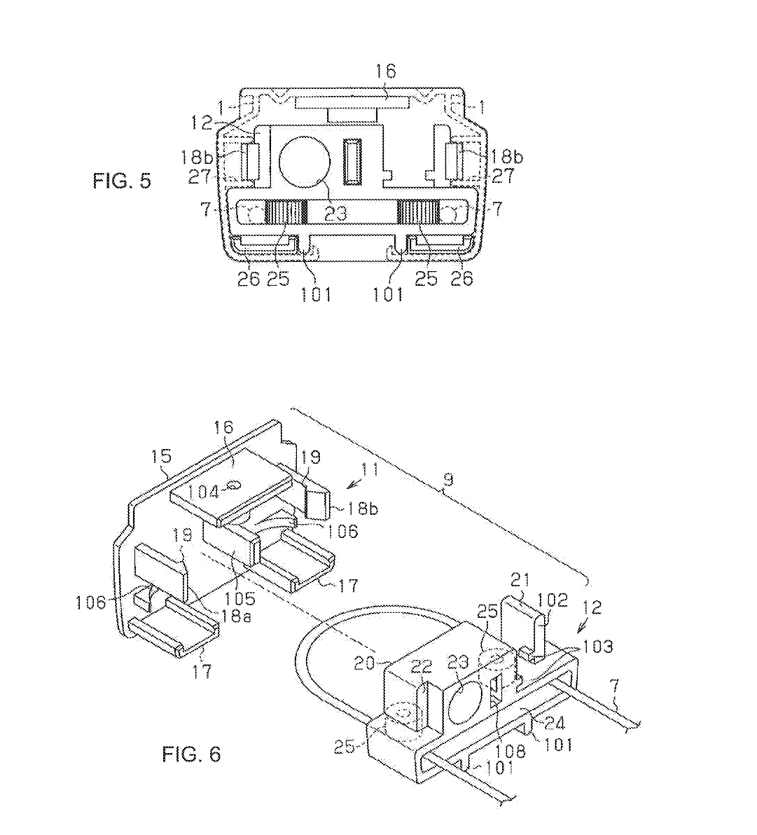

Next, the specific configuration of the cord support unit 9 will be described with reference to FIGS. 5 and 6. The cord support unit 9 includes a cap 11 which can be fitted to the end of the hanger rail 1 and an end case attached to the cap 11. Both the cap 11 and the end case 12 are formed of an elastic synthetic resin.

The cap 11 includes a planar portion 15 covering the end of the hanger rail 1. The planar portion 15 has, on upper and lower parts of the surface thereof opposed to the hanger rail 1, an upper guide piece 16 and a lower guide piece 17 which are both configured to guide the hanger rail 1 to the fitting position.

The planar portion 15 has, on front and rear parts of the surface thereof, a pair of locking pieces (restoration means or restoration members) 18a and 18b protruding in the same direction as the guide pieces 16 and 17 protrude. The locking pieces 18a and 18b have, at the front ends thereof, locking protrusions 19 protruding in such a manner to be in a mountain shape and be opposed to each other.

The upper guide piece 16 has, in the center thereof, a screw hole 104 for fixing the cap 11 to the hanger rail 1. Disposed below the upper guide piece 16 is a rectangular shaft-shaped guide protrusion 105 which extends from the cap 11 horizontally. Disposed on the front and rear sides of the guide protrusion 105 are guide portions 106 configured to guide the operation cord 7 engaged with guide rollers 25 of the end spacer 10a. The guide rollers 25 will be described later.

The end case 12 serving as a guide member has a fitting portion 20 and a fitting piece 21 which are insertable between the locking pieces 18a and 18b of the cap 11. The fitting portion 20 has a step (holding surface) 22 with which the locking protrusion 19 of the locking piece 18a is engaged. The fitting piece 21 has a holding surface 102 with which the locking protrusion 19 of the locking piece 18b is engaged. The fitting portion 20 has a bearing hole 23 for supporting the angle adjustment shaft in such a manner that the angle adjustment shaft can rotate and relatively move in the shaft direction.

Disposed below the fitting portion 20 and the fitting piece 21 is a tubular portion 24 through which the operation cord 7 can be passed. As shown in FIGS. 4 and 5, the pair of guide rollers 25 having the operation cord 7 engaged therewith are rotatably supported in the tubular portion 24.

When the fitting portion 20 and the fitting piece 21 of the end case 12 are inserted between the locking pieces 18a and 18b with the operation cord 7 engaged with the guide rollers 25, the locking pieces 18a and 18b are expanded and move relative to the fitting portion 20 and the fitting piece 21. Then the locking protrusions 19 are elastically engaged with the step 22 and the holding surface 102 of the fitting piece 21. Thus, the end case 12 is held by the cap 11.

Between the fitting piece 21 and the fitting portion 20, a spacer holder 103 holds the end spacer 10a. The end case 12 has, on front and rear parts of the lower surface thereof, legs 101 which protrude downward. The fitting portion 20 has, next to the bearing hole 23, a rectangular hole (guide hole) 108 into which the guide protrusion 105 can be inserted.

By guiding the lower guide piece 17 along the lower surface of the tubular portion 24 and the legs 101 and then inserting the guide protrusion 105 into the rectangular hole 108, the end case 12 is attached to the cap 11. Since the locking protrusions 19 of the locking pieces 18a and 18b are engaged with the step 22 and the holding surface 102, the end case 12 is elastically held by the cap 11.

According to the above configuration, the end case 12 is stably supported by the lower guide piece 17 and the guide protrusion 105. Further, since the lower guide piece 17 is guided along the lower surface of the tubular portion 24 and the legs 101, it can be guided stably.

Even when the end case 12 is detached from the cap 11, the end case 12 is easily held by the cap 11 again by using the guide protrusion 105 and the lower guide piece 17.

The end case 12 is held by a force that prevents the end case 12 from being detached from the cap 11 when the guide rollers 25 are subjected to a tensile force P (see FIG. 4) based on a tensile force applied to the operation cord 7 when normally drawing out or folding up the slats. On the other hand, when a force exceeding the tensile force P is applied to the end case 12 by both the cord portions of the operation cord 7, the locking pieces 18a and 18b of the cap 11 are disengaged from the fitting portion 20 and the fitting piece 21 of the end case 12. As a result, the end case 12 is detached from the cap 11. The locking pieces 18a and 18b of the cap 11 and the end case 12 function as positioning release means or positioning release mechanism.

As shown in FIG. 5, the tubular portion 24 of the end case 12 is inserted between a bottom 26 of the hanger rail 1 and ribs 27 protruding from inner side surfaces of the hanger rail 1. Accordingly, when the end case 12 is disengaged from the cap 11, it can move in the hanger rail 1. Note that while the end case 12 moves, the height of the fitting portion 20 and the fitting piece 21 (specifically, the step 22 and holding surface 102) of the end case 12 is maintained at the same height as that of the locking pieces 18a and 18b (specifically, the locking protrusions 19) of the cap 11. That is, the position relationship in height of the end case 12 with the cap 11 does not vary whether the end case 12 is engaged with the cap 11 or disengaged therefrom.

The cord support unit 9 thus configured is mounted on the hanger rail 1 by engaging the other endless edge of the operation cord 7 with the guide rollers 25 of the end case 12 at the left end of the hanger rail 1 and then attaching the end case 12 to the cap 11 mounted on the left end of the hanger rail 1.

Thus, the other endless edge of the operation cord 7 is supported by the left end of the hanger rail 1. By operating the operation cord 7 hanging from the right end of the hanger rail 1, the operation cord 7 moves in the hanger rail 1.

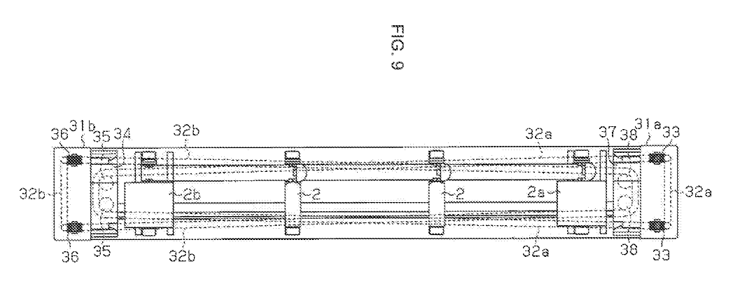

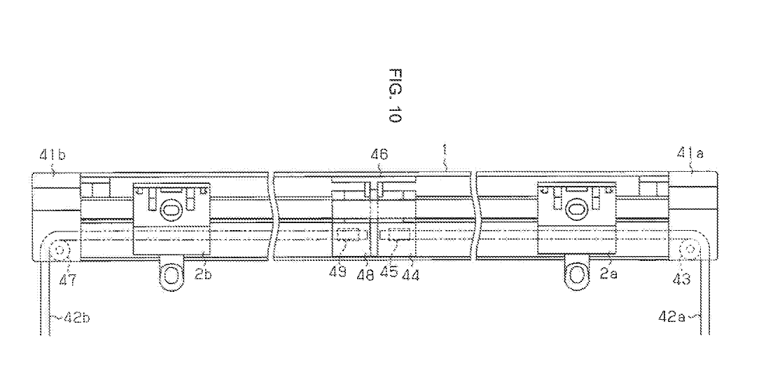

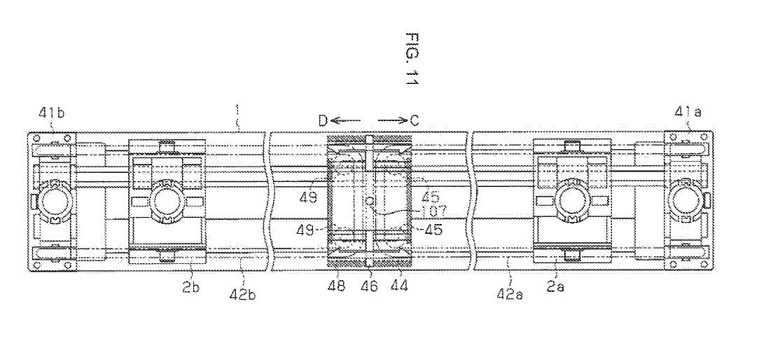

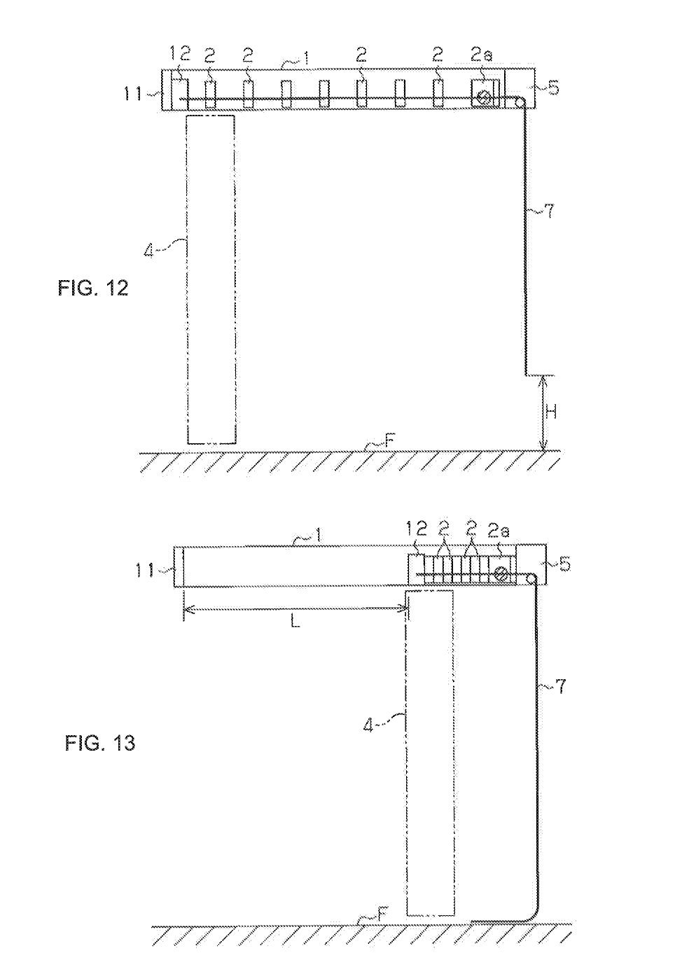

As shown in FIG. 12, the endless edge of the operation cord 7 hanging from the hanger rail 1 is maintained at a height H above the floor. Thus, ease of operation is increased, and the operation cord 7 is prevented from being stained due to contact with the floor F.

Next, effects of the vertical blind thus configured will be described.

By operating the operation cord 7 hanging from the hanger rail 1, the operation cord 7 in the hanger rail 1 moves in the direction of arrow A; the leading runner 2a moves in the same direction; and the slats 4 are drawn out toward the right end of the hanger rail 1.

Alternatively, by operating the operation cord 7, the operation cord 7 in the hanger rail 1 moves in the direction of arrow B; the leading runner 2a moves in the same direction; and the slats 4 are folded up toward the left end of the hanger rail 1. Further, by rotating the operation baton 6, the slats 4 are rotated in the same phase.

When a mobile object, such as a dweller, is caught on the operation cord 7 hanging from the right end of the hanger rail 1, a tensile force is applied to the cord portions of the operation cord 7 routed through the front and rear areas in the hanger rail 1 toward the right end of the hanger rail 1. Thus, a larger force than that applied when operating the operation cord 7 normally is applied to the end case 12.

As shown in FIG. 7, the end case 12 is detached from the cap 11 and moves to the right end of the hanger rail 1. As a result, the length of the operation cord 7 hanging from the right end of the hanger rail 1 is increased, allowing the dweller or the like to move.

As shown in FIG. 13, the maximum moving distance L of the end case 12 is the distance between the left end of the hanger rail 1 and the end case 12 in a state where the leading runner 2a and runners 2 are folded up between the operation unit 5 and the end case 12 at the right end of the hanger rail 1.

The maximum moving distance L is sufficiently longer than the height above the floor F of the endless edge of the operation cord 7 shown in FIG. 12. Accordingly, when the end case 12 travels the maximum moving distance L, the endless edge of the operation cord 7 hanging from the operation unit 5 sages on the floor F. Accordingly, when a dweller or the like is caught on the operation cord 7, the endless edge of the operation cord 7 is drawn until reaching the floor F. As a result, the mobile object can be easily released from the operation cord 7.

By releasing the dweller or the like from the operation cord 7, then moving the end case 12 along the hanger rail 1, and holding the end case 12 on the cap 11 again, there is restored a state where the slats 4 can be moved by operating the operation cord 7.

The operation apparatus for the vertical blind thus configured can show the following effects.

(1) When a dweller or the like is caught on the operation cord 7 hanging from the hanger rail 1, the end case 12 is detached from the cap 11, increasing the length of the operation cord 7 hanging from the hanger rail 1. As a result, the dweller or the like is not immediately hindered from moving.
(2) Since the maximum moving distance L of the end case 12 is set to a size larger than the height H above the floor F of the endless edge of the operation cord 7, it is possible to easily release the dweller or the like from the operation cord 7.
(3) By elastically fit the end case 12, detached from the cap 11, to the cap 11 again, it is possible to restore a state where the slats 4 can be moved using the operation cord 7.

### Second Embodiment

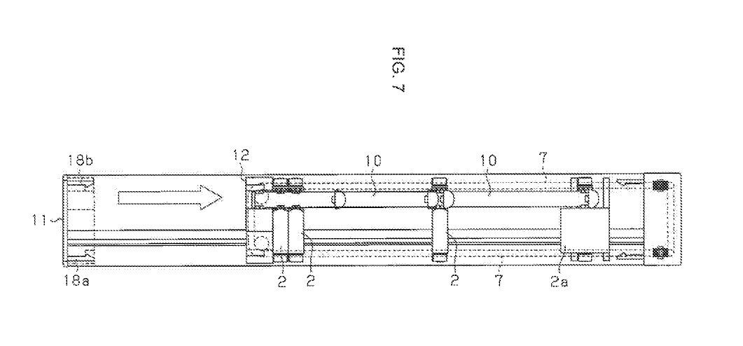

FIGS. 8 and 9 show a second embodiment. In the present embodiment, operation cords hang from both ends of a hanger rail, and by operating each operation cord, slats can be drawn out or folded up toward any of the right and left ends of the hanger rail. In the description, the same components as those in the first embodiment are given the same reference signs.

As shown in FIGS. 8 and 9, operation units 31a and 31b are mounted on the right and left ends of the hanger rail 1, and operation batons 6 hang from the operation units 31a and 31b. By operating any operation rod 6, slats hanging from runners 2, 2a, and 2b can be rotated in the same phase.

Endless edges of endless operation cords 32a and 32b hang from the operation units 31a and 31b, respectively. The operation cord 32a is guided around a guide roller 33 in the operation unit 31a into the hanger rail 1, and the other endless edge thereof is engaged with a guide roller 35 of an end case 34 held by the operation unit 31b. The leading runner 2a, which is the rightmost runner 2 in the hanger rail 1, is attached to one of front and rear cord portions of the operation cord 32a routed in the hanger rail 1.

Since the end case 34 and the operation unit 31b are similar to the end case 12 and cap 11 of the first embodiment, the end case 34 is elastically held by the operation unit 31b.

The operation cord 32b is guided around a guide roller 36 in the operation unit 31b into the hanger rail 1, and the other endless edge thereof is engaged with a guide roller 38 of an end case 37 held by the operation unit 31a. The leading runner 2b, which is the leftmost runner in the hanger rail 1, is attached to one of cord portions of the operation cord 32b routed through front and rear areas in the hanger rail 1.

Since the end case 37 and the operation unit 31a are similar to the end case 12 and cap 11 of the first embodiment, the end case 37 is elastically held by the operation unit 31a.

Next, effects of the vertical blind thus configured will be described.

By operating the operation cord 32a hanging from the right end of the hanger rail 1, the leading runner 2b is moved and thus the slats are drawn out toward the right end of the hanger rail 1 or folded up toward the left end thereof.

On the other hand, by operating the operation cord 32b hanging from the left end of the hanger rail 1, the leading runner 2a moves and thus the slats are drawn out toward the left end of the hanger rail 1 or folded up toward the right end thereof.

When a dweller or the like is caught on the operation cord 32a hanging from the hanger rail 1, the end case 34 is detached from the operation unit 31b and thus the length of the operation cord 32a hanging from the hanger rail 1 is increased.

On the other hand, when a dweller or the like is caught on the operation cord 32b hanging from the hanger rail 1, the end case 37 is detached from the operation unit 31a and thus the length of the operation cord 32b hanging from the hanger rail 1 is increased.

The operation apparatus for the vertical blind thus configured can show the effects shown in the first embodiment, as well as the following effects.

(1) Even when a dweller or the like is caught on any of the operation cord 32a and 32b hanging from both ends of the hanger rail 1, the dweller or the like is not immediately hindered from moving.
(2) Since locking pieces are formed integrally with the operation units 31a and 31b, an increase in parts number is prevented. Accordingly, the present embodiment is suitable for mass production, as well as allows for downsizing.

### Third Embodiment

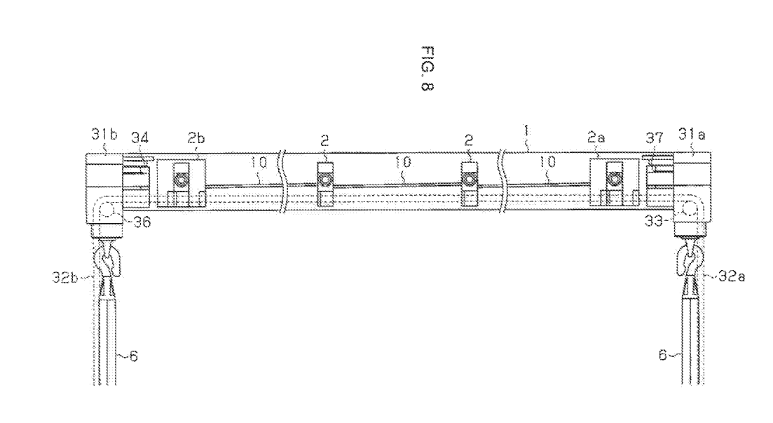

FIGS. 10 and 11 show a third embodiment. The present embodiment shows a separate-type vertical blind, where slats are folded up from both ends toward the lengthwise center of a hanger rail or drawn out from the lengthwise center toward both ends. Alternatively, by disposing the leading runners adjacent to both ends of the hanger rail, the slats may be drawn out from both ends of the hanger rail toward the center.

Operation units 41a and 41b are mounted on both ends of the hanger rail 1, and endless edges of endless operation cords 42a and 42b hang from the operation units 41a and 41b, respectively.

The operation cord 42a is guided around a guide roller 43 in the operation unit 41a into the hanger rail 1, and the other endless edge thereof is engaged with a guide roller 45 of an end case 44 held in the lengthwise center of the hanger rail 1.

A leading runner 2a, which is the rightmost runner in the hanger rail 1, is attached to one of cord portions of the operation cord 42a routed through front and rear areas in the hanger rail 1.

Since the end case 44 and a separate stopper 46 fixed to the lengthwise center of the hanger rail 1 are similar to the end case 12 and cap 11 of the first embodiment, the end case 44 is elastically held by the separate stopper 46. The separate stopper 46 is fixed to the hanger rail 1 by a screw inserted into a screw hole 107 formed in the center thereof.

The operation cord 42b is guided around a guide roller 47 in the operation unit 41b into the hanger rail 1, and the other endless edge thereof is engaged with a guide roller 49 of an end case 48 held by the separate stopper 46. A leading runner 2b, which is the leftmost runner in the hanger rail 1, is attached to one of cord portions of the operation cord 42b routed through front and rear areas in the hanger rail 1.

Since the end case 48 and the separate stopper 46 are similar to the end case 12 and cap 11 of the first embodiment, the end case 48 is elastically held by the separate stopper 46.

Alternatively, there may be employed a configuration where two angle adjustment shafts for rotating the slats are supported by the separate stopper 46 and where the slats suspended and supported on the respective sides of the separate stopper 46 can be rotated independently using respective operation batons hanging from both ends of the hanger rail 1.

Although the operation batons for rotating the slats are not shown in FIG. 10 or 11, the operation batons are suspended from and supported by both ends of the hanger rail 1, and the slats can be transferred by operating the operation batons. The end cases 44 and 48 can be transferred along the hanger rail 1. By operating any operation baton to press the end case 44 or 48 against the separate stopper 46, the end case 44 or 48 is easily held by the separate stopper 46 again.

Next, effects of the vertical blind thus configured will be described.

By operating the operation cord 42a hanging from the right end of the hanger rail 1, the leading runner 2a moves and thus the slats are drawn out toward the right end of the hanger rail 1 or folded up toward the lengthwise center thereof.

On the other hand, by operating the operation cord 42b hanging from the left end of the hanger rail 1, the leading runner 2b moves and thus the slats are drawn out toward the left end of the hanger rail 1 or folded up toward the lengthwise center thereof.

When a dweller or the like is caught on the operation cord 42a hanging from the hanger rail 1 and thus a tensile force is applied to the pair of cord portions of the operation cord 42a routed through front and rear areas in the hanger rail 1 in the same direction, the end case 44 is detached from the separate stopper 46 and moves in the direction of arrow C. Thus, the length of the operation cord 42a hanging from the hanger rail 1 is increased.

On the other hand, when a dweller or the like is caught on the operation cord 42b hanging from the hanger rail 1, the end case 48 is detached from the separate stopper 46 and moves in the direction of arrow D. Thus, the length of the operation cord 42b hanging from the hanger rail 1 is increased.

The length of the operation cords 42a and 42b to be increased is previously set to a size greater than the distance between the endless edges of the operation cords 42a and 42b and the floor. Thus, the dweller or the like is not hindered from moving.

The operation apparatus for the vertical blind thus configured can show the effects shown in the first embodiment, as well as the following effects.

(1) If a dweller or the like is caught on any of the operation cords 42a and 42b of the separate-type vertical blind, in which the slats located on the left and right sides in the hanger rail 1 can be operated independently by using the operation cords 42a and 42b hanging from both ends of the hanger rail 1, the dweller or the like is not immediately hindered from moving.
(2) By operating any operation baton, the end case 44 or 48 can be easily held by the separate stopper 46 again. By hanging the operation batons from near the end cases 44 and 48, the work of causing the separate stopper 46 to hold the end cases 44 and 48 is further facilitated.
(3) Since the bearing for the angle adjustment shaft and the locking piece are formed integrally with the separate stopper 46, an increase in parts number is prevented. Accordingly, the present embodiment is suitable for mass production and allows for downsizing.
(4) The separate stopper 46 is movably inserted into the hanger rail 1. Thus, by mounting the end cases 44 and 48 on both sides of the separate stopper 46 and then moving the separate stopper 46 to the center of the hanger rail 1, the separate stopper and the end cases 44 and 48 are easily mounted on the hanger rail 1.

### Fourth Embodiment

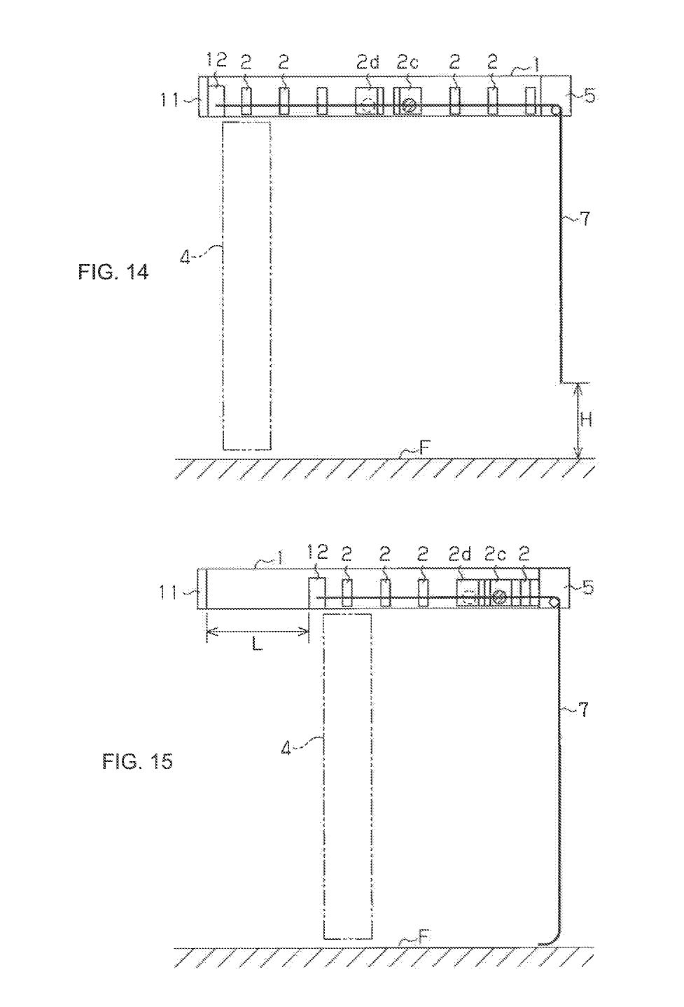

FIGS. 14 and 15 show a fourth embodiment. In the present embodiment, the present invention is applied to a double-sided vertical blind, in which by operating an operation cord, slats are drawn out from both ends toward the lengthwise center of a hanger rail or folded up from the lengthwise center toward both ends of the hanger rail. In the description, the same components as those in the first embodiment are given the same reference signs.

As shown in FIG. 14, leading runners 2c and 2d are movably supported on the middle portion of a hanger rail 1, and many runners 2 are movably supported between the leading runner 2c and an operation unit 5 and between the leading runner 2d and a cap 11.

Cord portions of an operation cord 7 are movably routed in the hanger rail 1. For example, the leading runner 2c is connected to the cord portion routed through a front area in the hanger rail 1, and the leading runner 2d is connected to the cord portion routed through a rear area therein. The other configuration is similar to that of the first embodiment.

In the vertical blind thus configured, by operating the operation cord 7 in one direction, the leading runner 2c moves toward the right end of the hanger rail 1, and the leading runner 2d moves toward the left end thereof. Thus, the slats 4 are folded up toward both ends of the hanger rail 1.

In contrast, by operating the operation cord 7 in the other direction, the leading runners 2c and 2d move toward the lengthwise center of the hanger rail 1, and the slats 4 are drawn out toward the lengthwise center thereof.

When a dweller or the like is caught on the operation cord 7 hanging from the operation unit 5, a tensile force is applied to both the cord portions routed through the front and rear areas in the hanger rail 1 toward the right end of the hanger rail 1. A larger force than when operating the operation cord 7 normally is applied to the end case 12.

Thus, as shown in FIG. 15, the end case 12 is detached from the cap 11 and moves toward the right end of the hanger rail 1. As a result, the length of the operation cord 7 hanging from the right end of the hanger rail 1 is increased, allowing the dweller or the like to move.

The maximum moving distance L of the end case 12 is a distance that the end case 12 travels until the runners 2 between the leading runner 2c and the operation unit 5, and the leading runners 2c and 2d are folded up toward the right end of the hanger rail 1.

The maximum moving distance L is sufficiently longer than the height above the floor F of the endless edge of the operation cord 7 shown in FIG. 14. When the end case 12 travels the maximum moving distance L, the endless edge of the operation cord 7 hanging from the operation unit 5 sags on the floor F, as shown in FIG. 15. As seen above, when a mobile object such as a dweller is caught on the operation cord 7, the endless edge of the operation cord 7 is drawn until reaching the floor F. As a result, the mobile object can be easily released from the operation cord 7.

The operation apparatus for the vertical blind thus configured can show the effects shown in the first embodiment, as well as the following effects.

(1) Even when a dweller or the like is caught on the operation cord 7 of the double-sided vertical blind, where by using the single operation cord 7 hanging from the hanger rail 1, the slats 4 are simultaneously folded up toward both ends of the hanger rail 1 or drawn out toward the lengthwise center thereof, the dweller or the like is not hindered from moving.

### Fifth Embodiment

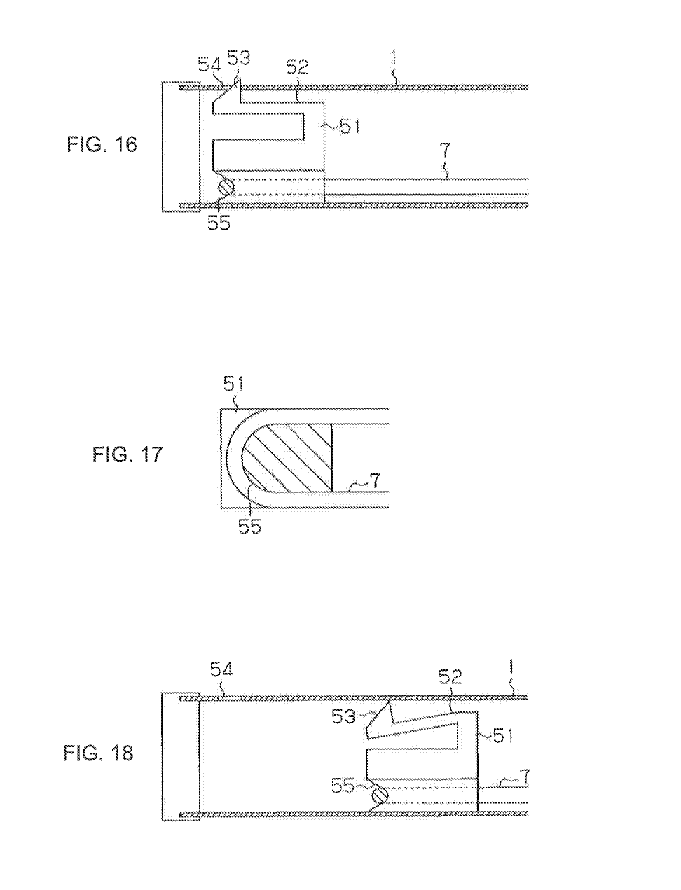

FIGS. 16 to 18 show a fifth embodiment. In the present embodiment, there is shown another example of an end case which supports an operation cord at an end of a hanger rail in such a manner that the operation cord can move around.

As shown in FIGS. 16 and 17, an end case 51 having an operation cord 7 engaged therewith has an elastic piece 52 as an upper portion thereof. A protrusion 53 formed at the front end of the elastic piece 52 is engaged with a locking hole 54 formed in the upper surface of a hanger rail 1. The elastic piece 52 is locking means or locking member for elastically holding the end case 51 on the hanger rail 1.

The end case 51 has, in a lower portion thereof, a guide groove 55 for turning around the operation cord 7 in an arc shape of a semicircle. The operation cord 7 is engaged with the guide groove 55.

According to the above configuration, the protrusion 53 and the locking hole 54 are usually engaged with each other and thus the end case 51 is held at the end of the hanger rail 1. The operation cord 7 is turned around along the guide groove 55 and moved.

When a dweller or the like is caught on the operation cord 7 and thus a large tensile force is applied to both the cord portions of the operation cord 7 engaged with the end case 51, the protrusion 53 of the elastic piece 52 is disengaged from the locking hole 54. Thus, as shown in FIG. 18, the end case 51 slides in the hanger rail 1.

According to the above configuration, when a tensile force is applied to front and rear portions of the end case 51, which is usually held at the end of the hanger rail 1, the end case 51 moves in the direction of the tensile force applied by the operation cord 7.

The operation apparatus thus configured can show the following effects.

(1) Since the position of the end case 51 is determined by the position of the locking hole 54, the end case 51 can be disposed in a position remote from the end of the hanger rail 1 or in the center of the hanger rail 1.
(2) The end cap of the hanger rail 1 is not necessarily needed; omitting it can reduce the number of parts.

Note that instead of forming the locking hole 54, the protrusion 53 of the elastic piece 52 may be locked at the end of the hanger rail 1.

### Sixth Embodiment

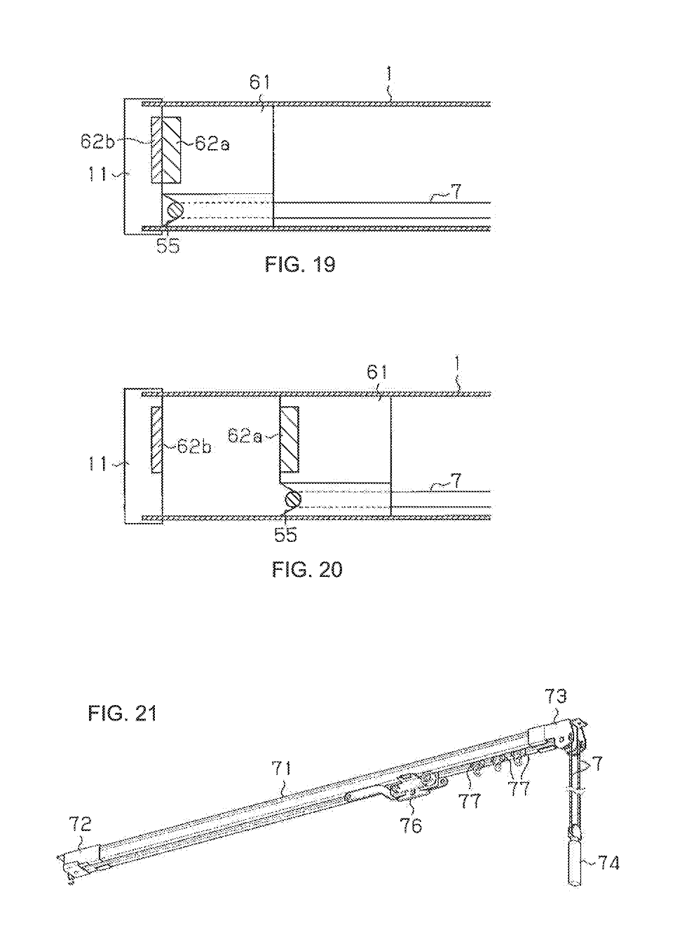

FIGS. 19 and 20 show a sixth embodiment. In the present embodiment, magnets 62a and 62b are used as means for holding the end case 61 on the cap 11.

The magnets 62a and 62b are attached to the opposite end faces of the end case 61 and the cap 11, respectively, and attract each other. A guide groove 55 for guiding an operation cord 7 is similar to that in the fifth embodiment.

According to the above configuration, the magnets 62a and 62b usually attract each other and thus the end case 61 is held at the end of the hanger rail 1. The operation cord 7 is turned around along the guide groove 55 and moved.

When a dweller or the like is caught on the operation cord 7 and thus a large tensile force is applied to both the cord portions of the operation cord 7 engaged with the end case 61, the magnets 62a and 62b, which attract each other, are separated. Thus, as shown in FIG. 20, the end case 61 slides in the hanger rail 1.

As seen above, when a large tensile force is applied to the end case 61, which is usually held at the end of the hanger rail 1, the end case 61 moves in the direction of the tensile force applied by the operation cord 7.

The length by which the cord portions of the operation cord 7 are drawn out from the hanger rail 1 when the dweller or the like is caught on the operation cord 7 is previously set to a size larger than the distance between the endless edge of the operation cord 7 and the floor. Accordingly, the dweller or the like is not hindered from moving.

Further, by causing the magnet 62b of the cap 11 to attract the magnet 62a of the end case 61 after the dweller or the like is released from the operation cord 7, there can be easily restored a state in which the operation cord can move around in the hanger rail 1.

### Seventh Embodiment

FIGS. 21 to 25 show a seventh embodiment. In the present embodiment, the present invention is applied to an operation apparatus for a curtain.

In a curtain operation apparatus shown in FIG. 21, a first cord support unit 72 is disposed at one end of a curtain rail 71, and a second cord support unit 73 is disposed at the other end. An endless operation cord 7 is routed in the curtain rail 71 in such a manner that the operation cord 7 can move around. One endless edge of the operation cord 7 hangs from the second cord support unit 73, as well as has a weight 74 engaged therewith and thus the operation cord in the curtain rail 71 is stretched.

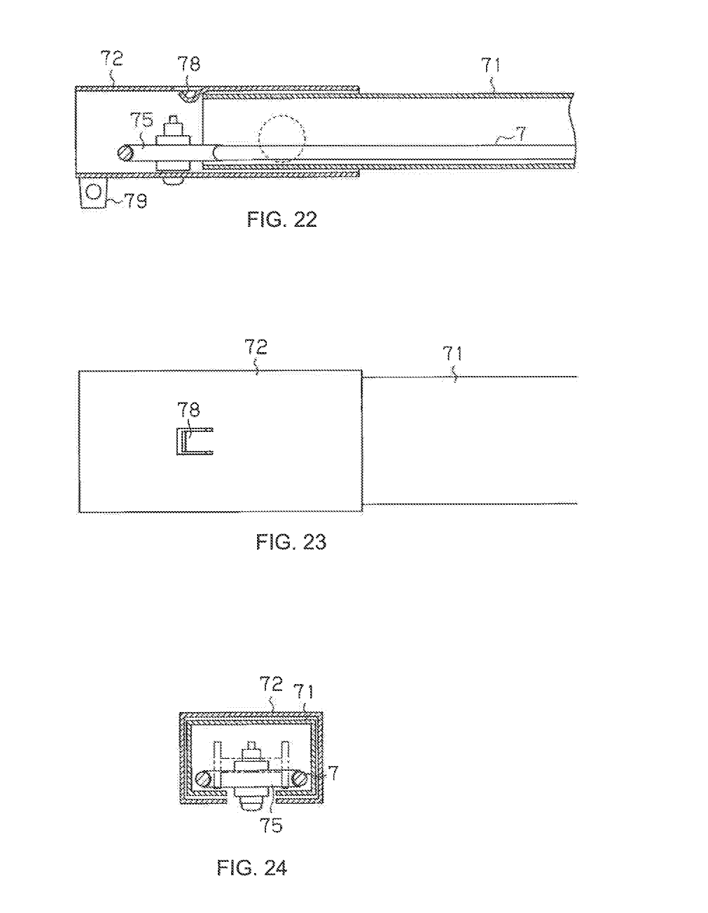

FIG. 21 shows only a leading runner 76 and runners 77 for moving a curtain fabric on the right side in the double-sided curtain; it omits a leading runner and runners for moving a curtain fabric on the left side. A curtain hook at the left edge of the left curtain fabric is suspended from and supported by a suspension portion 79 shown in FIG. 22.

As shown in FIG. 22, the other endless edge of the operation cord 7 is engaged with a pulley 75 which is rotatably supported in the first cord support unit 72.

By operating the operation cord 7 hanging from the second cord support unit 73, the operation cord 7 moves around in the curtain rail 71. Then the leading runner 76 and the following runners 77 move along the curtain rail 71. Thus, the curtain fabrics suspended from and supported by the runners are drawn out from both ends toward the center of the curtain rail 71 or folded up toward both ends thereof.

The first cord support unit 72 has a tubular shape which can be fitted into the curtain rail 71 and has an elastic piece 78 on the upper surface thereof. Usually, the elastic piece 78 is elastically engaged with the edge of the curtain rail 71 and positioned against the tensile force of the operation cord 7 engaged with the pulley 75.

The length by which the cord portions of the operation cord 7 in the curtain rail 71 can be drawn out from the curtain rail 71 is set to a size larger than the distance between the endless edge of the operation cord 7 and the floor. Accordingly, the dweller or the like is not hindered from moving.

The first cord support unit 72 has the suspension portion 79 for suspending and supporting one edge of the curtain fabric.

According to the above configuration, the first cord support unit 72 is usually held at the end of the curtain rail 71, and the operation cord 7 is turned around along the pulley 75 and moved.

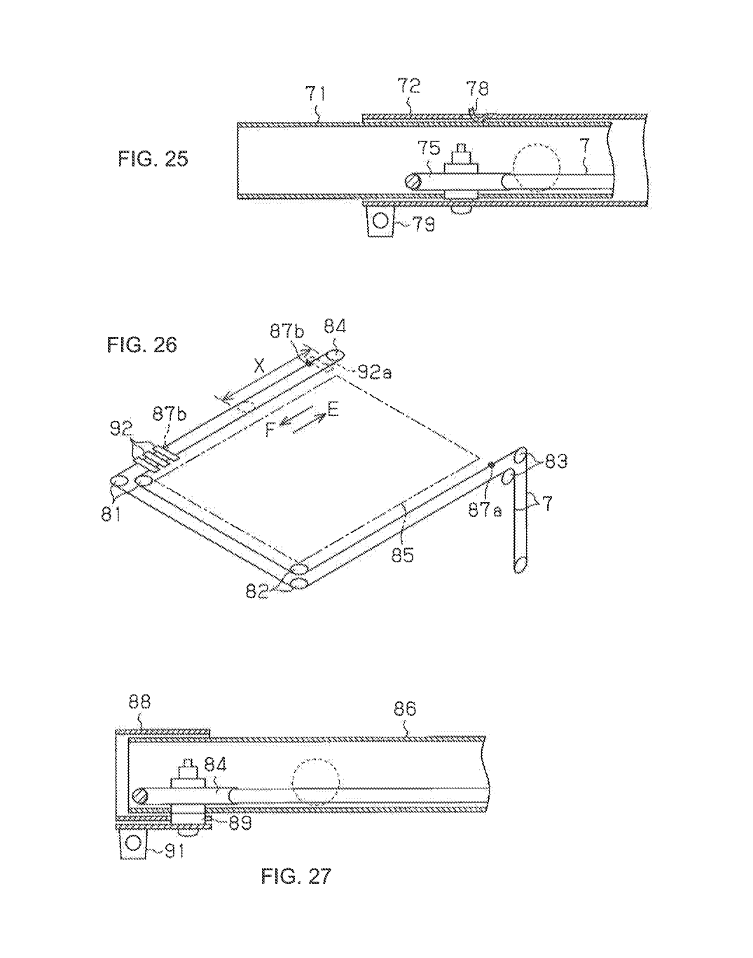

When a dweller or the like is caught on the operation cord 7 and thus a large tensile force is applied to both the cord portions of the operation cord 7 engaged with the end case 61, the elastic piece 78 is disengaged from the edge of the curtain rail 71. Thus, as shown in FIG. 25, the first cord support unit 72 serving as a guide member moves along the external surfaces of the curtain rail 71.

As seen above, when a tensile force is applied to the first cord support unit 72, which is usually held at the end of the hanger rail 1, the first cord support unit 72 moves in the direction of the tensile force applied by the operation cord 7.

Since the suspension portion 79, which suspends and supports the edge of the curtain fabric, also moves along with the first cord support unit 72, the first cord support unit 72 can be moved easily.

The operation apparatus thus configured can show the following effects.

(1) Since the curtain edge on the non-operation side also moves, the curtain fabric does not interfere with a fail safe operation.

### Eighth Embodiment

FIGS. 26 to 30 show an eighth embodiment. In the present embodiment, the present invention is applied to an operation apparatus for a skylight curtain.

In an operation apparatus for a skylight curtain shown in FIG. 26, curtain rails 86 are disposed on the left and right sides of a curtain fabric. An endless operation cord 7 is movably routed along the curtain rails 86 around a pair of guide pulleys 81, a pair of guide pulleys 82, a pair of guide pulleys 83, and an end pulley 84. One endless edge of the operation cord 7 hangs from the guide pulleys 83 downward. FIG. 26 shows a single-sided skylight curtain where a curtain fabric 85 is drawn out in the direction of arrow E or folded up in the direction of arrow F.

The curtain rails 86 as shown in FIG. 27 are disposed between the end pulley 84 and the guide pulleys 81 and between the guide pulleys 82 and the guide pulleys 83. The curtain fabric 85 is supported, at equal intervals, by many runners 92 which are movably supported by the curtain rails 86. FIG. 26 omits the runners between the guide pulleys 82 and the guide pulleys 83.

By operating the operation cord 7, the curtain fabric 85 is drawn out in the direction of arrow E or folded up in the direction of arrow F.

A leading runner 92a is fixed to one cord portion of the operation cord 7 between the guide pulleys 82 and the guide pulleys 83 using a leading runner fixture 87a; another leading runner 92a is fixed to the other cord portion of the operation cord 7 between the guide pulleys 81 and the end pulley 84 using a leading runner fixture 87b.

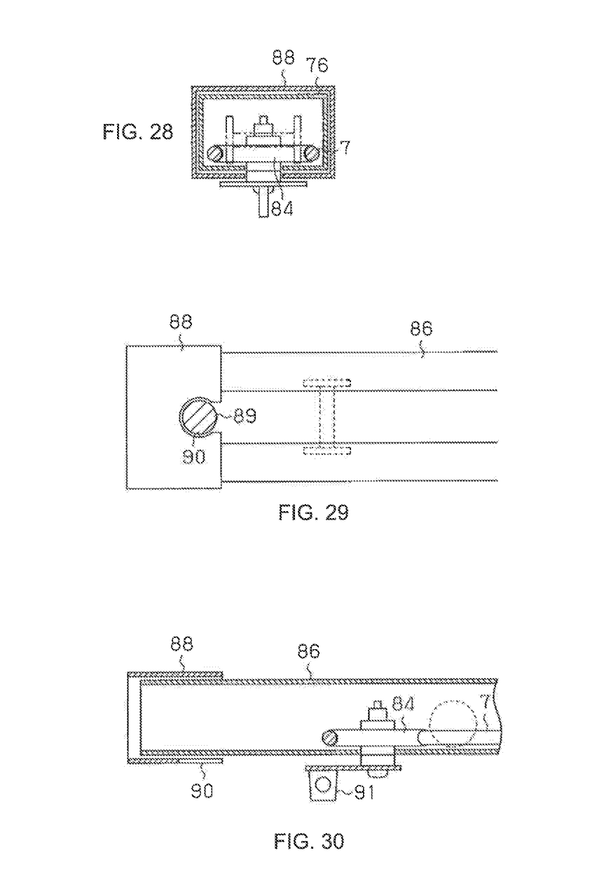

As shown in FIGS. 27 and 28, the end pulley 84, which has the operation cord 7 engaged therewith and serves as a guide portion (or guide member), is elastically held by a cap 88 which is mounted on an end of the curtain rail 86. Specifically, as shown in FIG. 29, the cap 88 has, in a lower portion thereof, a holding hole 90 which can hold a spindle 89 for the end pulley 84. The holding hole 90 is open in the direction of a tensile force applied by the operation cord 7.

The width of the opening is slightly smaller than the diameter of the spindle 89. The spindle 89 is held in the holding hole 90 during a normal operation, in which a tensile force is applied to one of the cord portions of the operation cord 7.

When a dweller or the like is caught on the operation cord 7 hanging from the guide pulleys 83 and thus a tensile force exceeding a normal tensile force is applied to the spindle 89, the spindle 89 is detached from the holding hole 90 and thus the end pulley 84 moves along the curtain rail 86, as shown in FIG. 30.

Attached to the lower end of the spindle 89 is a suspension portion 91 configured to suspend and support the edge of the curtain fabric.

According to the above configuration, during a normal operation, the end pulley 84 is held by the cap 88 at the end of the curtain rail 86, and the operation cord 7 is turned around along the end pulley 84 and moved. Thus, the curtain fabric 85 is drawn out in the direction of arrow E or folded up in the direction of arrow F.

When a dweller or the like is caught on the operation cord 7 and thus a large tensile force is applied to both the cord portions of the operation cord 7 engaged with the end pulley 84, the spindle 89 is disengaged from the holding hole 90 and thus the end pulley 84 moves along the curtain rail 86.

At this time, the leading runner fixture 87a contacts the guide pulley 83. Thus, the cord portion to which the leading runner fixture 87a is attached is hindered from further moving. As a result, only the cord portion to which the leading runner fixture 87a is not attached is drawn from the guide pulley 83 downward and thus the runners 92, the leading runner fixture 87b, and the end pulley 84 move in the direction of arrow F shown in FIG. 26. When the end pulley 84 travels the movable distance X, the runners 92 between the guide pulleys 81 and the end pulley 84 are folded up near the guide pulleys 81 and hindered from further moving. Accordingly, the end pulley 84 is also hindered from further moving.

The movable distance X is previously set to about half the distance between the end pulley 84 and the guide pulleys 81. The length by which both cord portions of the operation cord 7 are drawn out from the guide pulleys 83 is previously set to a size larger than the distance between the endless edge of the operation cord 7 and the floor. Accordingly, a dweller or the like is not hindered from moving.

According to the above configuration, the length of the operation cord 7 hanging from the guide pulleys 83 is increased by the movable distance X. Thus, the dweller or the like is allowed to move, as well as can be easily released from the operation cord 7.

The present invention is also applicable to a double-sided skylight curtain in which leading runners are movably disposed on two curtain rails 86; an operation cord 7 is engaged with the leading runners; and curtain fabrics can be opened or closed toward the center or both ends of the curtain rails 86. Since a suspension portion 91 suspending and supporting the edge of the curtain fabric moves along with an end pulley 84, the end pulley 84 can be moved easily.

The above embodiments may be carried out in the following mode.

In the first and eighth embodiments, the present invention may be applied to a double-sided mode in which two leading runners are fixed to the front and rear cord portions, respectively, of an operation cord.

The above operation apparatuses can be used in curtains where a curtain fabric is movably suspended from and supported by a curtain rail and skylight curtains, as well as in panel curtains where a panel-shaped curtain fabric is movably suspended from and supported by a curtain rail.

### DESCRIPTION OF NUMERALS

1: rail (hanger rail), 4: sunlight shading material (slat), 7: operation cord, 9: cord support unit, 12, 34, 37, 44, 48: positioning release means (guide member, end case), 18a, 18b: positioning release means, restoration means, locking means (locking piece)

1-24. (canceled)

25. An operation apparatus for a sunlight shielding apparatus, the sunlight shielding apparatus comprising:
a sunlight shielding material;
a rail configured to support the sunlight shielding material in such a manner that the sunlight shielding material is movable; and
an endless operation cord supported by the rail in such a manner that the operation cord can move around along the rail, wherein
the sunlight shielding material is transferred along the rail as the operation cord moves around in the rail,
the operation cord comprises:
a pair of cord portions extending in parallel with each other along the rail;
a first endless edge which is a junction of first ends of the cord portions; and
a second endless edge which is a junction of second ends of the cord portions,
the first endless edge hangs from one end of the rail,
the second endless edge is supported in the rail through a cord support unit, and
the cord support unit comprises:
positioning release means configured to, when a tensile force is applied to both the cord portions at the second endless edge, release positioning of the second endless edge with respect to the rail; and
a guide member configured to, when the positioning of the second endless edge is released, allow the second endless edge to move at least until the first endless edge reaches a floor.

26. The operation apparatus of claim 25, wherein
the positioning release means comprises restoration means configured to elastically restore the positioning of the second endless edge with respect to the rail.

27. The operation apparatus of claim 26, wherein
the restoration means comprises an operation baton capable of transferring, to the positioning release means, an end case with which the operation cord is engaged.

28. The operation apparatus of claim 25, wherein
the positioning release means comprises locking means attached to the rail and configured to elastically hold an end case included in the cord support unit.

29. The operation apparatus of claim 25, wherein
the cord support unit comprises:
a cap mounted on an end of the rail; and
an end case with which the operation cord is engaged, the end case being movably supported by the rail, and
the positioning release means comprises a locking piece disposed on the cap and configured to elastically hold the end case.

30. The operation apparatus of claim 29, wherein
the cap comprises a planar portion covering an end of the rail, and
the locking piece protrudes from the planar portion.

31. The operation apparatus of claim 30, wherein
the cap comprises a guide protrusion protruding from the planar portion, and
the end case has a guide hole into which the guide protrusion can be inserted.

32. The operation apparatus of claim 25, wherein
the cord support unit comprises:
an operation unit attached to an end of the rail; and
an end case with which the operation cord is engaged, the end case being movably supported by the rail, and
the positioning release means comprises a locking piece disposed on the operation unit and configured to elastically hold the end case.

33. The operation apparatus of claim 32, wherein
the operation units are mounted on both ends of the rail,
the operation units hold the end cases, respectively,
the operation cord engaged with the end case located at a left end of the rail hangs from a right end of the rail, and
the operation cord engaged with the end case located at the right end of the rail hangs from the left end of the rail.

34. The operation apparatus of claim 25, wherein
the cord support unit comprises:
a separate stopper attached to a lengthwise middle portion of the rail;
a first end case with which the operation cord hanging from a right end of the rail is engaged, the first end case being movably supported by the rail; and
a second end case with which the operation cord hanging from a left end of the rail is engaged, the second end case being movably supported by the rail, and
the positioning release means comprises a locking piece disposed on the separate stopper and configured to elastically hold the first and second end cases.

35. The operation apparatus of claim 29, wherein
the locking piece comprises a locking protrusion, and
the end case has a holding surface capable of being engaged with the locking protrusion.

36. The operation apparatus of claim 35, wherein
the end case disengaged from the locking piece can move around along the rail with a height of the holding surface maintained at a height of the locking piece.

37. The operation apparatus of claim 27, wherein
the end case is movably supported in the rail.

38. The operation apparatus of claim 27, wherein
the end case has a bearing hole into which an angle adjustment shaft configured to rotate the sunlight shielding material can be inserted.

39. The operation apparatus of claim 25, wherein
the positioning release means comprises locking means disposed on the end case with which the operation cord is engaged, the locking means being configured to elastically hold the end case on the rail.

40. The operation apparatus of claim 39, wherein
the locking means is an elastic piece disposed on the end case, and
the elastic piece is configured to be engaged with an end of the rail or a locking hole formed in the rail.

41. The operation apparatus of claim 25, wherein
the positioning release means elastically holds, on the rail, a guide portion with which the operation cord is engaged.

42. The operation apparatus of claim 25, wherein
the positioning release means is configured to, when there is applied a tensile force exceeding a tensile force applied to the operation cord when transferring the sunlight shielding material, release the positioning of the second endless edge with respect to the rail.

43. A cord support unit for a sunlight shielding apparatus, the sunlight shielding apparatus comprising:
a sunlight shielding material;
a rail configured to support the sunlight shielding material in such a manner that the sunlight shielding material is movable; and
an endless operation cord supported by the rail in such a manner that the operation cord can move around along the rail, wherein
the sunlight shielding material is transferred along the rail as the operation cord moves around in the rail,
the operation cord comprises:
a pair of cord portions extending in parallel with each other along the rail;
a first endless edge which is a junction of first ends of the cord portions; and
a second endless edge which is a junction of second ends of the cord portions,
the first endless edge hangs from one end of the rail,
the second endless edge is supported in the rail through the cord support unit, and
the cord support unit comprises positioning release means configured to, when a tensile force is applied to both the cord portions at the second endless edge in the same direction, release positioning of the second endless edge with respect to the rail.

44. A cord support unit attached to a lengthwise middle portion of a rail of a sunlight shielding apparatus, the cord support unit comprising:
a first end case with which an operation cord hanging from a right end of the rail is engaged, the first end case being movably supported by the rail;
a second end case with which an operation cord hanging from a left end of the rail is engaged, the second end case being movably supported by the rail; and
a locking piece disposed on the lengthwise middle portion of the rail and configured to elastically hold the first and second end cases.
